(19) United States
(12) Patent Application Publication
(10) Pub. No.: US 2018/0242739 A1
(43) Pub. Date: Aug. 30, 2018

(54) Systems for Shielding, Protecting, and Decorating Valued Surfaces and Products Thereby

(71) Applicant: Kimberly K. Adams, The Colony, TX (US)

(72) Inventor: Kimberly K. Adams, The Colony, TX (US)

(21) Appl. No.: 15/899,983

(22) Filed: Feb. 20, 2018

Related U.S. Application Data
(60) Provisional application No. 62/461,072, filed on Feb. 20, 2017.

(51) Int. Cl. A47B 96/20; A47B 96/18; A47J 47/00

(52) U.S. Cl. CPC A47B 96/205; A47J 47/005; A47B 96/18

(57) ABSTRACT

A system for providing functional and decorative elements for shielding, which is an easily stored and foldable large piece of protective coverage, preserving the integrity of at least the upper surface of a working space, likewise the system is crafted for counters, tables and the like by offering quasi-customized and faux/simulacros designs such as Carrera marble, silastone, colors, wood, patterned designs (such as wallpaper designs) and other ornamental and artistic or customized features. An application for smart devices facilitates rapid generation of finished pieces according to the present invention.

### CROSS REFERENCE TO RELATED CASES

This application claims the benefit of, and priority to, U.S. Provisional Patent Application Ser. No. 62/461,072, filed Feb. 20, 2017, the content of which is incorporated herein by reference herein in its entirety.

### BACKGROUND OF THE DISCLOSURES

Large expandable, reusable, protective and decorative (like a large coaster over a coffee table, kitchen countertop, dining room table) or any work surface that needs to be protected against damage. These could come in standard kitchen island, table, coffee table sizes and easily bought in mass market stores such as Bed, Bath, Beyond, Macy's, Sur la table, etc. They could be very high end and also low end and customizable as well. Makes clean up super simple & easy.

There are NOT large enough coverage options in the mass-market stores where you can walk in and buy off the shelf. Materials being used in homes now are so high end and expensive such as marbles, stones, that consumers are afraid of damaging the surfaces in kitchen, dining room table, coffee tables, etc. When consumer are cutting, prepping food, juicing or doing anything in a kitchen or home where you would need to protect your high-end original finishes.

According to the present invention—Mass market reach first. Easily stored and foldable large piece of protective coverage that would come in faux designs such as Carrera marble, silastone, colors, wood, designs, (such as wallpaper designs.) Phase II: Custom designs, consumers use pictures or their own drawn images. Quasi-custom and numerous other options.

Expandable surface area protection that fold like accordion style. Can easily expand and store this large protective surface. Very heavy-duty plastic that possible has a rubber in-between pieces of the protective covering that allows for folding and cleaning and storing easily.

According to embodiments there is disclosed an articulated, rounded device for covering the active surface of another article, having an upper and a lower surface, whereby hinged assemblies divide the device into foldable segments, allowing it to be stored in a more compact fashion.

According to embodiments there is disclosed an articulated, rounded device for covering the active surface of another article, further comprising a plurality of joint means, each bending in the same ordinal plane to allowed for an accordion-like folding of the device.

According to embodiments there is disclosed a modular covering apparatus for a cutting board or squared or rectangulated or hexagonalized active counter surface comprising a shielding member and at least two rubberized plasticized or otherwise crafted joint means for connecting each said modular piece together by foldable and storable devices attached to each said modular piece to form a shape.

According to embodiments there is disclosed a computer and/or specialized processor based system for customizing small medium and large valuable surfaces of claim 14, comprising, in combination, at least a template generating user interface having a plurality of shape and surface elements settings, whereby a user may customize a design for a system for decoratively covering a surface.

According to embodiments there is disclosed a system for offering quasi-customized and faux/simulacros designs such as Carrera marble, silastone, colors, wood, patterned designs (such as wallpaper designs) and other ornamental and artistic or customized features.

According to embodiments there is disclosed a modular covering apparatus for a cutting board or squared or rectangulated or hexagonalized active counter surface of claim 14, offering quasi-customized designs such as Carrera marble, silastone, colors, wood, patterned designs (such as wallpaper designs) and other ornamental and artistic or customized features.

According to embodiments, there is provided a modular covering apparatus for a cutting board or squared or rectangulated or hexagonalized active counter surface comprising a shielding member and at least two rubberized plasticized or otherwise crafted joint means for connecting each said modular piece together by foldable and storable devices attached to each said modular piece to form a shape.

### BRIEF DESCRIPTION OF THE DRAWINGS

Various preferred embodiments are described herein with references to the drawings in which merely illustrative views are offered for consideration, whereby:

FIG. 1 is a schematic showing a cutting board or other regular geometric version of the present inventions; and

FIG. 2 is a schematic of a rounded version of the instant disclosures, which come in customized and quasi-customized and quasi-randomized shapes.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTIONS

The present inventor has designed covers for active (for example) counter spaces which need to be preserved in terms of surface integrity, inter alia.

In prototype form, art elements and decorative features are combined to provide a modular covering apparatus for a cutting board or squared or rectangulated or hexagonalized active counter surface comprising a shielding member and at least two rubberized plasticized or otherwise crafted joint means for connecting each said modular piece together by foldable and storable devices attached to each said modular piece to forth a shape.

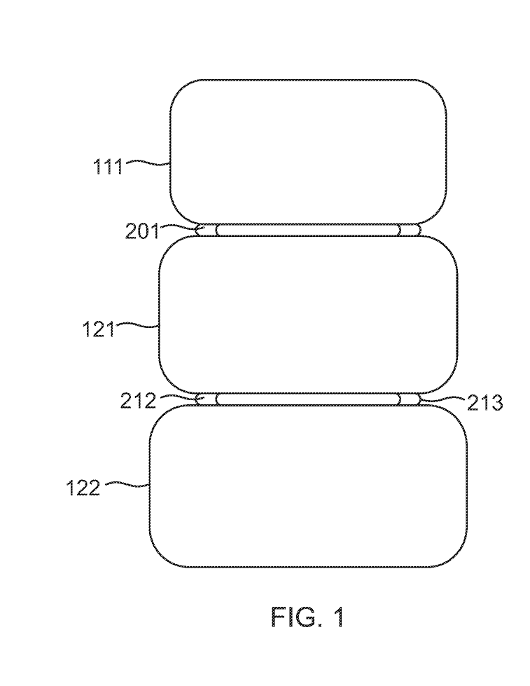

Referring now to FIG. 1, cutting board for kitchen counter 101 is comprised of modular elements 111, 121, 122 and joining member 201, 212, 213, as discussed herein and claimed below. Artisans understand this is a schematic view and any geometry may be used and be within the scope of the instant invention.

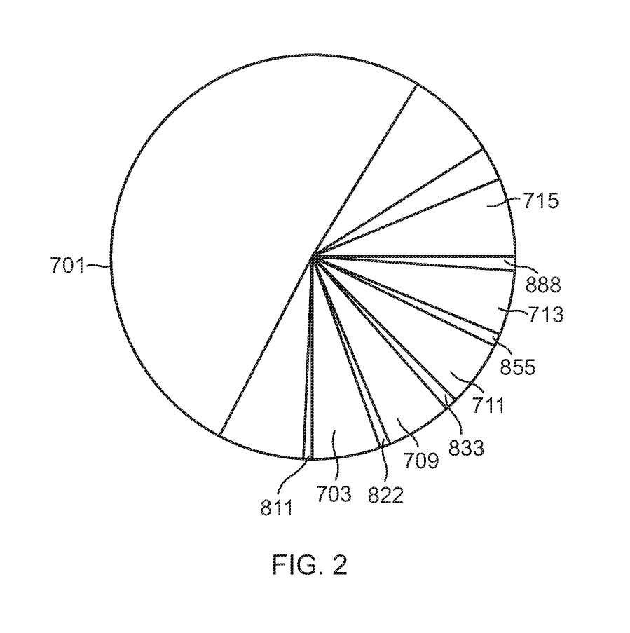

Referring now also to FIG. 2, a circular table 701, has different accordion-like segments 703, 709, 711, 713 and 715. Respective joint means are shown at 811, 822, 833, 855 and 888.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language mans that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, Intel Core I & Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A system for providing both functional and decorative elements for shielding, comprising, in combination:
At least a modular piece of protective coverage having and upper and lower surface to cover the top of an article having an upper surface; and,
One or more joining members or connection elements associated therewith;
Whereby the at least one modular piece of protective covering can be disposed on the top of the upper surface of the article to be covered creating a second surface shielding the article to be covered from impacts from other material, when the system is arranged in a first or flattened position.

2. The system of claim 1, wherein the one or more joining members or connection elements are operatively linked to the at least a modular piece of protective coverage, by attachment thereto, such that the at least one modular piece may be folded to a configuration smaller than its first or flattened position, into a second or folded position.

3. The system of claim 2, the at least a modular piece of protective coverage effective for preserving surface integrity of at least the upper surface of article having an upper surface being covered.

4. The system of claim 3, the at least a modular piece of protective coverage having an upper surface selected from the group of pre-existing patterns and one to be customized based upon the article having an upper surface or related interior design issues.

5. The system of claim 4, designed for use to cover an active surface.

6. The system of claim 5, wherein the active surface is a counter top, such as a kitchen counter top used for food preparation and/or baking preparation, inter alia.

7. The system of claim 6, wherein the at least a modular piece of protective coverage is designed to cover a rectangular area on the surface of the article to be covered.

8. The system of claim 7, wherein the at least a modular piece of protective coverage is designed to cover a curvilinear area on the surface of the article to be covered.

9. The system of claim 8, wherein the at least a modular piece of protective coverage is designed to cover a rounded or elliptical area on the surface of the article to be covered.

10. The system of claim 9, wherein the at least modular piece of protective coverage is designed to cover another geometrical shape area on the surface of the article to be covered.

11. The system of claim 10, wherein the at least a modular piece of protective coverage is designed to cover another amorphous area on the surface of the article to be covered.

12. An articulated, rounded device for covering the active surface of another article, having an upper and a lower surface, whereby hinged assemblies divide the device into foldable segments, allowing it to be stored in a more compact fashion.

13. The articulated, rounded device for covering the active surface of another article of claim 12, further comprising a plurality of joint means, each bending in the same ordinal plane to allow for an accordion-like folding of the device.

14. A modular covering apparatus for a cutting board or squared or rectangulated or hexagonalized active counter surface comprising a shielding member and at least two rubberized plasticized or otherwise crafted joint means for connecting each said modular piece together by foldable and storable devices attached to each said modular piece to form a shape.

15. A computer and/or specialized processor based system for customizing small medium and large valuable surfaces of claim 14, comprising, in combination:
At least a template generating user interface having a plurality of shape and surface elements settings, whereby a user may customize a design for a system for decoratively covering a surface.

16. The system of claim 7, offering quasi-customized and faux/simulacros designs such as Carrera marble, silastone, colors, wood, patterned designs (such as wallpaper designs) and other ornamental and artistic or customized features.

17. The articulated rounded device of claim 13, offering quasi-customized and faux/simulacros designs such as Carrera marble, silastone, colors, wood, patterned designs (such as wallpaper designs) and other ornamental and artistic or customized features.

18. The modular covering apparatus for a cutting board or squared or rectangulated or hexagonalized active counter surface of claim 14, offering quasi-customized and faux/simulacros designs such as Carrera marble, silastone, colors, wood, patterned designs (such as wallpaper designs) and other ornamental and artistic or customized features.
